(19) United States
(12) Patent Application Publication
(10) Pub. No.: US 2009/0279750 A1
(43) Pub. Date: Nov. 12, 2009

(54) Fingerprint reader

(75) Inventor: Kazutaka Kochi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/458,667

(22) Filed: Jul. 20, 2009

Related U.S. Application Data
(63) Continuation of application No. PCT/JP2007/051044, filed on Jan. 24, 2007.

(51) Int. Cl. G06K 9/00

(52) U.S. Cl. 382/124

(57) ABSTRACT

A fingerprint reader includes a base that is provided with a round concave which is roundly recessed along at least a predetermined direction in a part of a surface of the base; a projection section that is arranged in one end of the round concave in the predetermined direction, and that protrudes from a concave surface of the round concave; and a fingerprint sensor that has an operation surface on the projection section, and that detects a fingerprint of a finger which passes on the operation surface in the predetermined direction.

### CROSS-REFERENCE TO RELATED APPLICATION

This is a continuation application of PCT/JP2007/051044, filed on Jan. 24, 2007.

### FIELD

The embodiment discussed herein is related to a fingerprint reader having a fingerprint sensor that detects a fingerprint of a finger.

### BACKGROUND

Recently, a technique in which an authentication whether a person in question is a right person as is performed by detecting and checking a fingerprint electronically has been introduced into a device or the like relating to security.

Among fingerprint readers to electronically detect a fingerprint, there is a type that requires a user to lay a finger pad of the user in a concave which is fatter than the finger and expands straight and to move the laid finger backwardly along a longitudinal direction of the concave, and that detects a fingerprint of the finger moving in the concave by using a fingerprint sensor arranged on the way in the longitudinal direction of the concave.

However, as an movement of the elbow is indispensable for the action of pulling the finger straight backwardly, the action being required for the above-mentioned type of fingerprint reader, a lot of users tend to move their own elbows not enough and to scratch a surface of the concave by a tip of the finger. When the finger moves in this manner, the finger pad pulls away from a surface of the concave so that a distance from the fingerprint sensor becomes large, and thus a detection accuracy of the fingerprint may be deteriorated.

Accordingly, a proposal to curve a shape of the concave for matching rising of the finger pad has been offered (see Refer to Japanese Laid-Open Patent No. 2005-352788).

According to the above-mentioned proposal, for the above-mentioned problem that the finger pad pulls away from the surface of the concave, the concave is curved along the direction of pulling the finger so that the finger pad moving along the surface of the curved concave readily contacts with an operation surface of the fingerprint sensor projecting from the surface of the concave.

However, the above-mentioned proposal is insufficient for that each part of the finger pad moving along the surface of the curved concave contacts completely and smoothly with the operation surface projecting from the surface of the concave, and a part of the finger pad does not contact enough with the operation surface, and thus the detection accuracy of the fingerprint may not be improved.

### SUMMARY

Accordingly, it is an object in one aspect of the invention to provide a fingerprint reader capable of improving a detection accuracy of a fingerprint.

According to an aspect of the invention, a fingerprint reader includes: a base that is provided with a round concave which is roundly recessed along at least a predetermined direction in a part of a surface of the base; a projection section that is arranged in one end of the round concave in the predetermined direction, and that protrudes from a concave surface of the round concave; and a fingerprint sensor that has an operation surface on the projection section, and that detects a fingerprint of a finger which passes on the operation surface in the predetermined direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an external perspective view of a fingerprint reader according to an embodiment of the invention;

FIG. 2 is a view of an appearance of the fingerprint reader viewed from above;

FIG. 3 is a sectional view along a line A-A′ of FIG. 2, of the fingerprint reader; and

FIG. 4 is a view illustrating a movement of a finger in the fingerprint reader according to the embodiment.

### DESCRIPTION OF EMBODIMENT(s)

Hereinafter there will be explained an embodiment of a fingerprint reader of the invention.

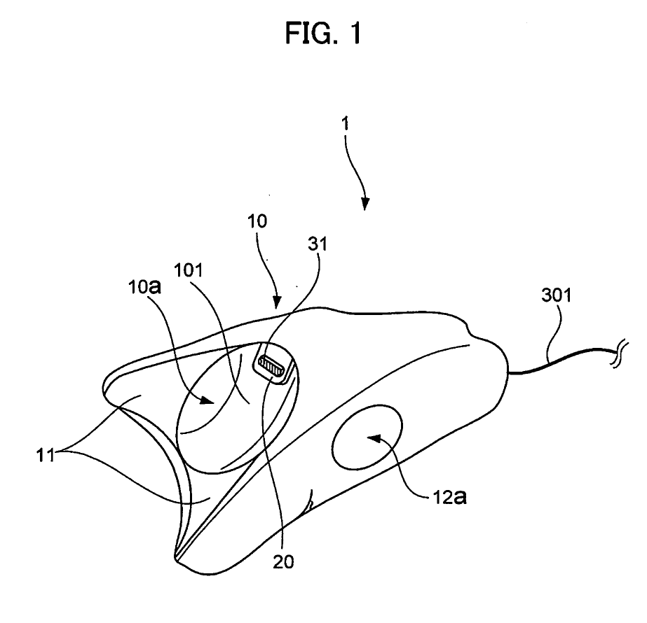

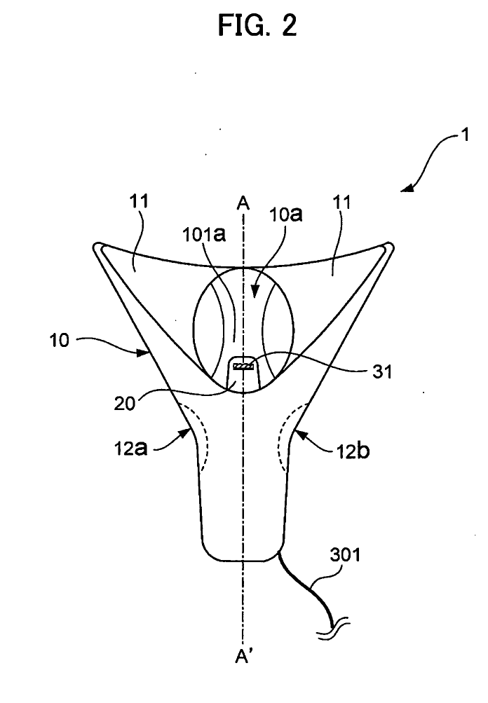

FIG. 1 and FIG. 2 are a perspective view and a top view of a fingerprint reader of the present invention as an embodiment, respectively.

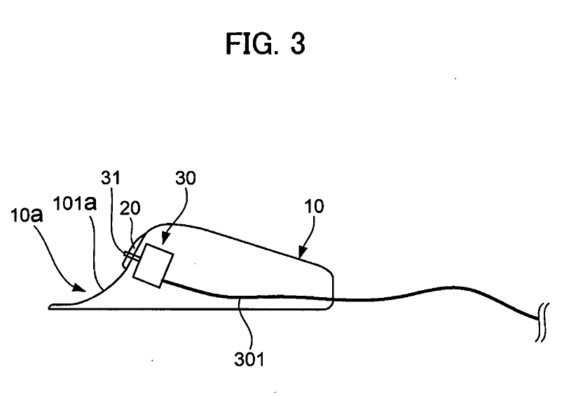

A fingerprint reader 1 of the present embodiment illustrated in FIG. 1 and FIG. 2 includes a base 10 and a fingerprint sensor 30 (see FIG. 3) to read a fingerprint. The fingerprint reader 1 is as large as fitting comfortably in the palm of a hand. The fingerprint reader 1 transmits data representing a detected fingerprint to a fingerprint analysis device not illustrated through a signal cable 301. In front of the base 10, there is provided a round concave section 10a which faces obliquely upward and outwardly and is roundly recessed. At both right and left sides of the base 10, there is provided each of a pair of outward-facing concave sections 12a and 12b which are recessed and facing outwardly to each other and in which fingers are put to hold the base 10. Other parts of the fingerprint sensor 30 except an operation surface 31 disposed at an edge of the round concave section 10a are housed in the base 10.

A user, for example, while looking at the fingerprint reader 1 as illustrated in FIG. 2, put the thumb of the user's right hand on the outward-facing concave section 12a provided on a left side of the base 10, and while putting the third finger of the right hand on the outward-facing concave section 12b provided on a right side of the base 10, the user lays a forefinger pad of the right hand on a concave surface 101a of the round concave section 10a, and moves the forefinger pad backwardly along the concave surface 101a that curves roundly in a front-and-back direction of the base 10 to pass on the operation surface 31, so that the user has a fingerprint of the user read by the fingerprint reader 1. The reason why the round concave section 10a is curved round as described is that it is a natural action for a person to move a finger along a surface curved like the round concave section 10a.

In addition, in FIG. 1 and FIG. 2, it is depicted that extension portions 11 are provided in pair, the extension portions each extending such that a distance between each narrows as approaching the round concave section 10a from right and left edges of the round concave section 10a. Due to the extension portions 11, even if a place where a finger is laid shifts to some extent from the round concave section 10a, the finger is guided to the round concave section 10a as the finger moves, and it is possible to prevent an occurrence of a situation that the finger approaches the operation surface 31 while being shifted. In addition, the user holds the outward-facing concave sections 12a and 12b provided on right and left sides of the base 10, the user may easily stabilize the fingerprint reader 1. Moreover, since positions of the thumb, the middle finger or the third finger of the hand are determined by the holding, the movement of the finger along the round concave section 10a is stabilized, so that the fingerprint detection may be held in a high accuracy by suppressing right and left shifting of the finger. In the fingerprint sensor 30, a lot of fine electrodes are arranged on a back side of the operation surface 31, and electric charge of an amount corresponding to the unevenness of a fingerprint of a finger contacting the operation surface is generated on fine electrodes of the fine electrodes corresponding to the unevenness in the position. The fingerprint sensor 30 detects fingerprints by detecting this charge.

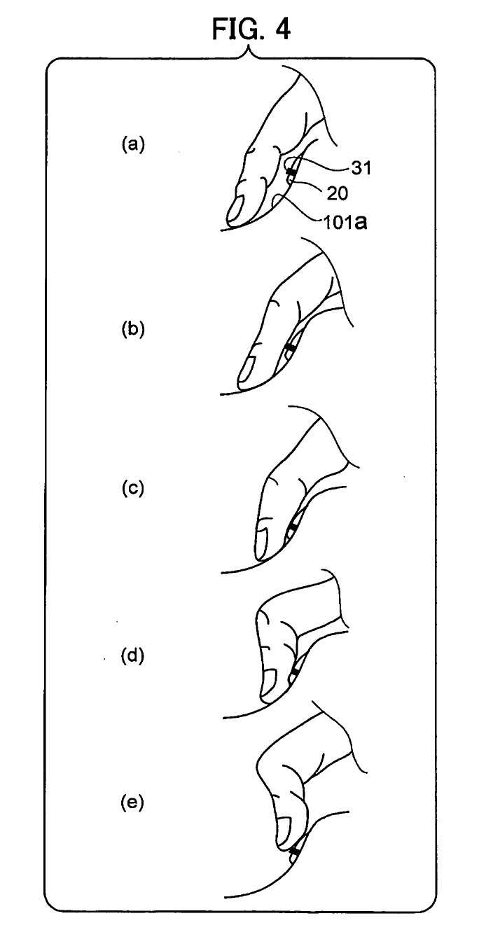

Here, as illustrated in FIG. 1 and FIG. 2, the fingerprint reader 1 is provided with a projection portion protruding from the concave surface 101a of the round concave section 10a. Hereinafter, there will be explained the function of the projection portion 20 with reference to FIG. 3 and FIG. 4.

FIG. 3 is a sectional view along a line A-A′ of FIG. 2, of the fingerprint reader.

In FIG. 3 are illustrated the projection portion 20 protruding from the concave surface 101a of the round concave section 10a, and the operation surface 31 arranged in the vicinity of a center of the projection portion 20. In FIG. 3 is further illustrated also the fingerprint sensor 30 provided in the base 10, and the signal cable 301.

FIG. 4 is a view illustrating a movement of a finger in the fingerprint reader according to the present embodiment.

A part (a) of FIG. 4 depicts the state in which a finger which is an object whose fingerprint is to be detected is laid on the concave surface 101a of the round concave section 10a. Then, the finger pad is laid on the concave surface 101a as illustrated in a part (b) of FIG. 4. The finger pad such laid on the concave surface 101a rides on the projection portion 20 as illustrated in a part (c) of FIG. 4. The part (c) of FIG. 4 depicts the state in which the vicinity of the first joint approaches the operation surface 31. In the fingerprint reader 1, the finger pad rides on the projection portion 20 sequentially, thereby strongly contacting with the operation surface 31. Subsequently, as illustrated from a part (d) of FIG. 4 to a part (e) of FIG. 4, the fingerprint is detected while the state is retained that each region of the portion from the first joint to the tip of the finger and the operation surface 31 contact strongly with one another. Therefore, according to the fingerprint reader 1 of the present embodiment, it is possible to improve the detection accuracy of a fingerprint.

Moreover, according to the fingerprint reader 1, it is so arranged that the operation surface 31 of the fingerprint sensor 30 is inclined toward a center side of the round concave section 10a. The reason why the operation surface 31 of the fingerprint sensor 30 is inclined in such direction is that a further improvement of the detection accuracy of the fingerprint is aimed in such a manner that when a finger moving from the front side to the back side of the base 10 along the concave surface 101a of the round concave section 10a approaches the operation surface 31, each part of the finger pad straightly faces the operation surface 31.

Further, according to the embodiment as explained above, a case where the outward-facing concave sections 12a and 12b are provided at right and left sides more backward than the arranged position of the operation surface 31 of the base 10 is exemplified. However, the invention is not limited to the position illustrated in FIG. 1 and FIG. 2 as far as the outward-facing concave sections are arranged in pair, facing outwardly to each other, sandwiching a part of the base 10 which part is more backward with respect to a hand holding the base 10 than the operation surface 31. Moreover, it is noted that omission of the concave sections 12a and 12b does not damage the basic effect of the present invention.

Further, according to the embodiment as explained above, a case where the extension portions 11 each extending respectively from right and left edges of the round concave section 10a are arranged. However, it is noted that omission of the extension portions 11 does not damage the basic effect of the invention. Moreover, it is noted that even if the operation surface 31 is not inclined to a center side of the round concave section 10a, the basic effect of the present invention is not damaged. In addition, according to the embodiment as explained above, the fingerprint sensor 30 of an electrostatic method type is exemplified for the explanation. In the invention, however, the fingerprint sensor may be an electric field method type or an optical method type other than the electrostatic method type.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A fingerprint reader comprising:
a base that is provided with a round concave which is roundly recessed along at least a predetermined direction in a part of a surface of the base;
a projection section that is arranged in one end of the round concave in the predetermined direction, and that protrudes from a concave surface of the round concave; and
a fingerprint sensor that has an operation surface on the projection section, and that detects a fingerprint of a finger which passes on the operation surface in the predetermined direction.

2. The fingerprint reader according to claim 1, wherein the fingerprint sensor has the operation surface being inclined to a center side of the round concave.

3. The fingerprint reader according to claim 1, wherein the base has extension portions which are arranged in pair adjacently to the round concave on a side opposite to a side where the operation surface is arranged, the extension portions extending such that a distance between each of the extension portions narrows as approaching the round concave.

4. The fingerprint reader according to claim 1, wherein the base has outward-facing concaves that are arranged in pair to be held by other fingers of a hand same as the hand of a finger whose fingerprint is detected by the fingerprint sensor, the outward-facing concaves facing outwardly to each other, sandwiching a part of the base which part is more backward with respect to the hand than the operation surface in a direction intersecting with the predetermined direction.
